(19) United States
(12) Patent Application Publication
(10) Pub. No.: US 2003/0022615 A1
(43) Pub. Date: Jan. 30, 2003

(54) Air vent

(75) Inventor: Matthias Hanft, Marktredwitz (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Electronics & Components GmbH & Co. KG

(21) Appl. No.: 10/200,687

(22) Filed: Jul. 22, 2002

(30) Foreign Application Priority Data
Jul. 25, 2001 (DE) 101 36 051.7

(51) Int. Cl. B60H 1/34

(52) U.S. Cl. 454/155

(57) ABSTRACT

An air vent, in particular for vehicular air conditioning, comprises a first blade pivotally mounted about a first axis in a frame, and a second blade pivotally mounted about a second axis in the frame. An operational control is arranged on the first blade and connected to the second blade via a slider/ball joint.

### TECHNICAL FIELD

The invention relates to an air vent, in particular for vehicular air conditioning. Such an air vent typically has several blades, the orientation of which can be adjusted for setting the direction of the air flow output by the air vent into the vehicle interior.

The objective of the invention is to provide an air vent having a particularly compact and simple structure.

### BRIEF SUMMARY OF THE INVENTION

According to the invention, an air vent, in particular for vehicular air conditioning, comprises a first blade pivotally mounted about a first axis in a frame, and a second blade pivotally mounted about a second axis in the frame. An operational control is arranged on the first blade and connected to the second blade via a slider/ball joint. Orienting the first blade can be directly set by means of the operational control. Orienting the second blade is done by shifting the operational control on the first blade. This results, in all, in a very compact structure, the air vent being composed of few individual components.

Advantageous aspects of the invention will be apparent from the sub-claims.

### BRIEF DESCRIPTION OF THE DRAWINGS

FIG. 1 is a diagrammatic plan view of an air vent according to the invention;

FIGS. 2a and 2b are sectional views of a first and second blade of the air vent taken along the planes a and b as shown in FIG. 1;

FIGS. 3a to 3d are a side view, a sectional view, a plan view and a view in perspective, respectively, in a first position of the blades as shown in FIG. 2;

FIGS. 4a to 4d are a side view, a sectional view, a plan view and a view in perspective, respectively, in a second position of the blades as shown in FIG. 2;

FIGS. 5a to 5d are a side view, a sectional view, a plan view and a view in perspective, respectively, in a third position of the blades as shown in FIG. 2; and

FIGS. 6a to 6d are a side view, a sectional view, a plan view and a view in perspective, respectively, in a fourth position of the blades as shown in FIG. 2.

### DETAILED DESCRIPTION OF THE PREFERRED EMBODIMENT

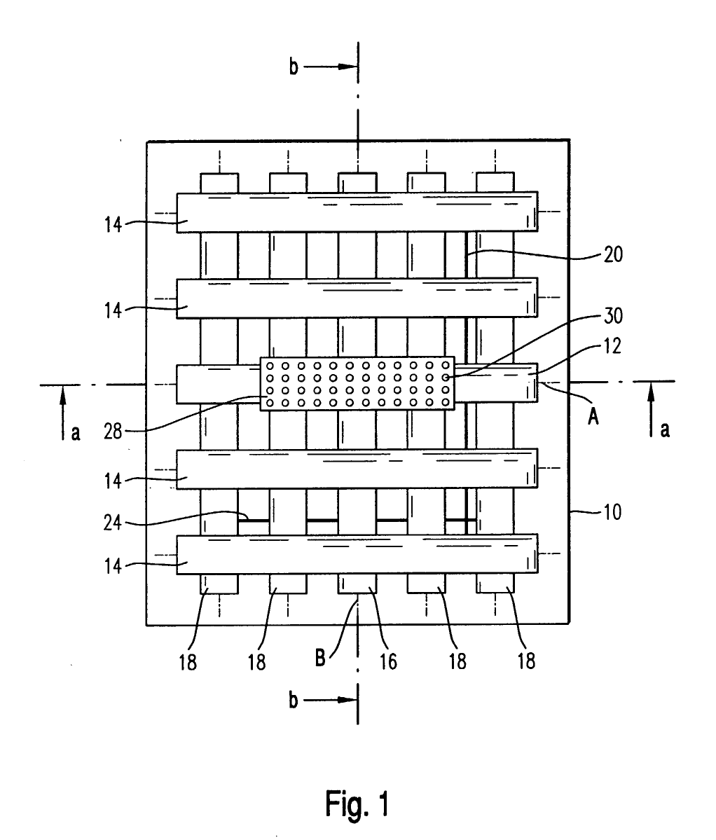

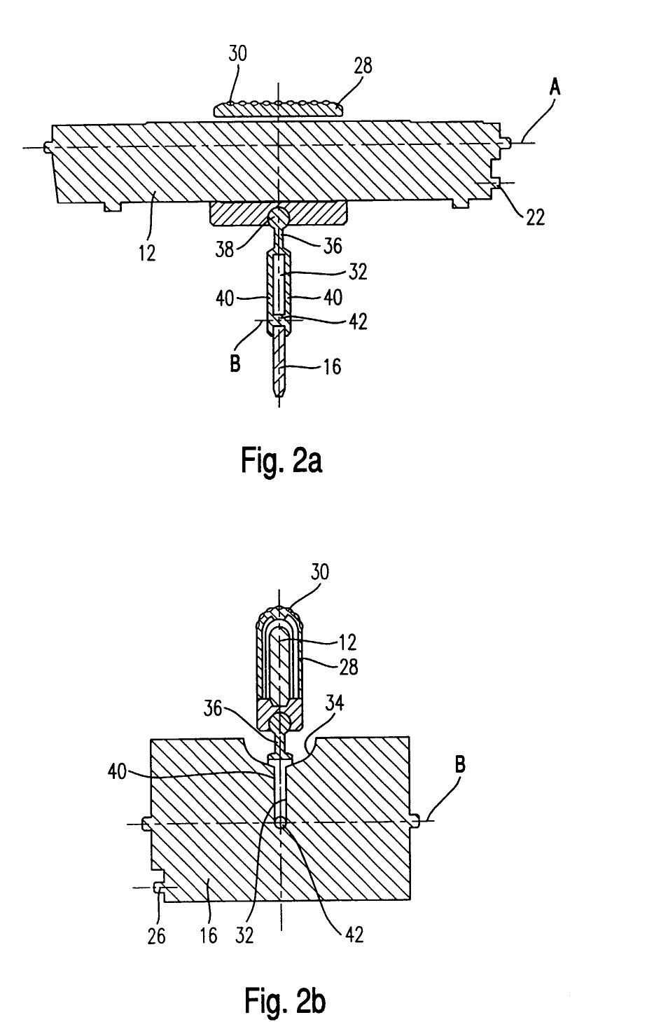

Referring now to FIG. 1 there is illustrated diagrammatically an air vent comprising a frame 10 in which a first blade 12 is pivotally mounted about a first axis A (see also FIGS. 2a, 2b). Arranged parallel to the first blade 12 are further blades 14, the pivotal axes of which are parallel to axis A.

Arranged perpendicular to the and below the first blade 12 in the frame 10 is a second blade 16 pivotally mounted about an axis B. Provided parallel to the second blade 16 are further blades 18 whose pivotal axes are parallel to the axis B.

The first blade 12 is connected to the further blades 14 by a coupling rod 20 mounted on a journal 22 (see FIG. 2a). The second blade 16 is connected to the further blades 18 by a coupling rod 24 mounted on journals 26 (see FIG. 2b). The coupling rods 20, 24 ensure that the first blade 12 and further blades 14, on the one hand, and the second blade 16 and the further blades 18, on the other, are always oriented parallel to each other.

Attached to the second blade 16 is an operational control 28 in such a way that it can be shifted along axis A on the first blade 12. For this purpose, the operational control 28 clasps the first blade 12 in a close fit, so that no separate guide is needed. At the outer side the operational control 28, a plurality of serrations 30 is provided to facilitate setting the operational control.

The second blade 16 is provided with a slot 32 extending perpendicular to the axis B and porting into a scallop 34 at the rim facing the first blade 12.

Disposed between the operational control 28 and the second blade 16 is a connecting part 36 forming a slider/ball joint between the operational control 28 and the second blade 16. At its end assigned to the operational control 28, the connecting part 36 comprises a ball 38 mounted in a complementary ball socket in the operational control 28, for which preferably a snap-in connection is used. At its side facing the second blade 16, the connecting part 36 comprises two side webs 40, the spacing of which from each other is slightly greater than the thickness of the second blade 16. Extending between the two side webs 40 is a cross web 42 which engages the slot 32 of the second blade 16. The two side webs 40 are slightly wider than the slot 32, so that the side webs 40 are always in contact with the side faces of the second blade 16.

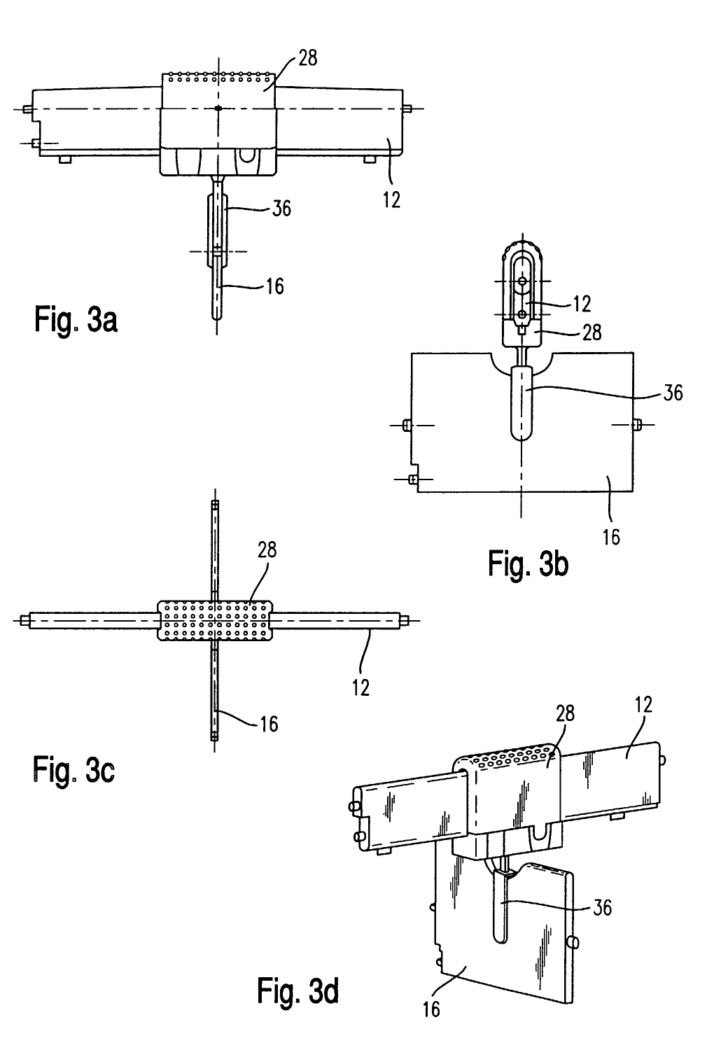

Referring now to FIGS. 3 to 6, various positions of the first and second blade 12, 16 will be detailed as obtainable by actuating the operational control of the first blade 12.

In the position as shown in FIG. 3, the first and second blade (and the further blades connected to the first and second blade) are in the non-pivoted position in which air flows straight through the air vent without being deflected.

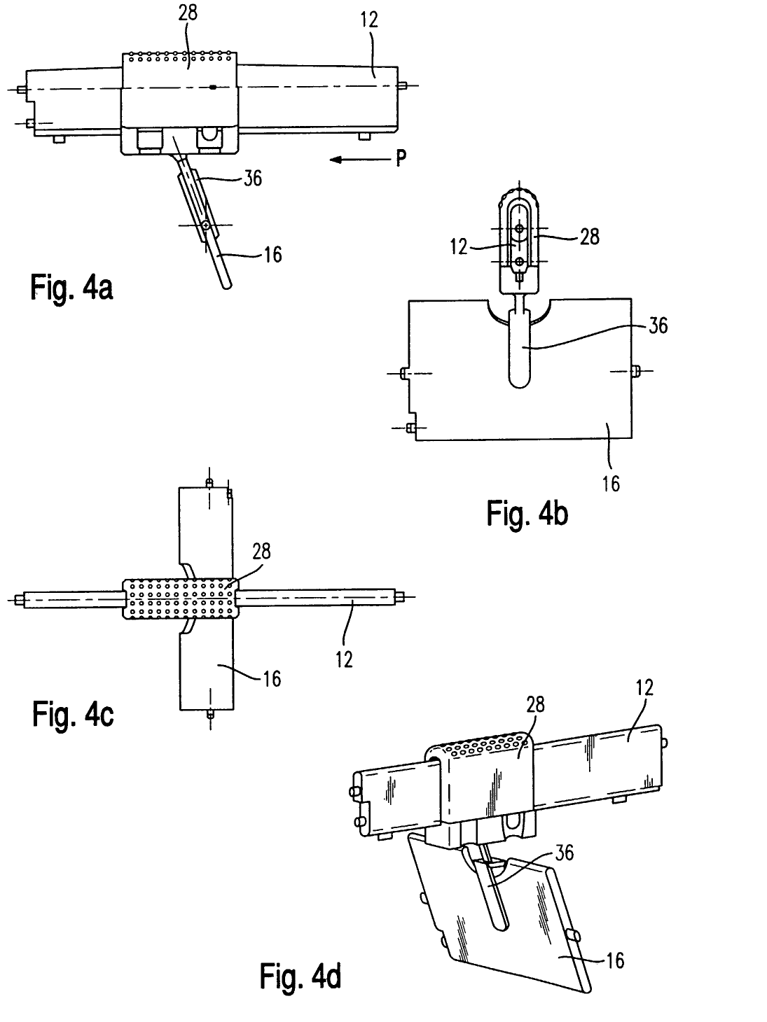

Referring now to FIG. 4, there is illustrated a position in which the second blade 16 is pivoted roughly by 20 degrees in one direction. This is achieved by means of the operational control 28 having been shifted on the first blade 12 in the direction of the arrow P as shown in FIG. 4a. The side webs 40 pivot the second blade 16, resulting in the connecting part 36 being turned about the ball 38 and the cross web 42 slides upwards in the slot 32.

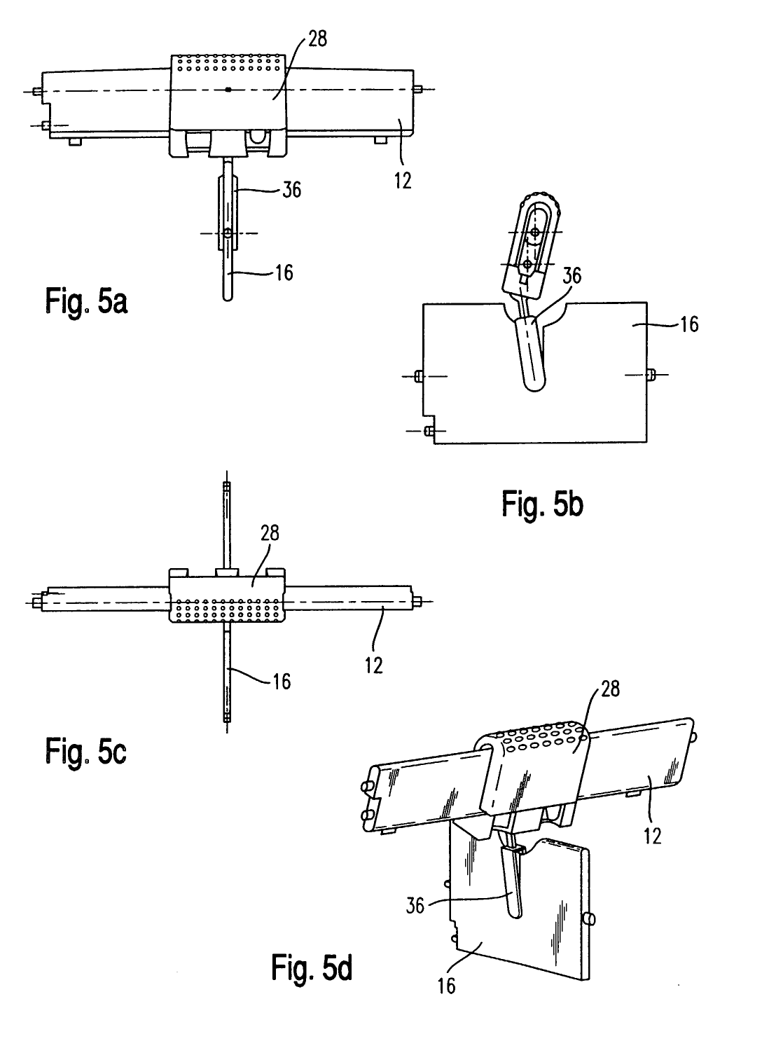

Referring now to FIG. 5, there is illustrated a position in which only the first blade 12 is pivoted roughly by 20 degrees, i.e. the second blade 16 remaining in its non-pivoted position. This positioning is achieved by means of the first blade 12 having been pivoted by means of the operational control 28 about axis A. In this movement too, the connecting part 36 is pivoted about the ball 38 and the cross web 42 slides upwards in the slot 32.

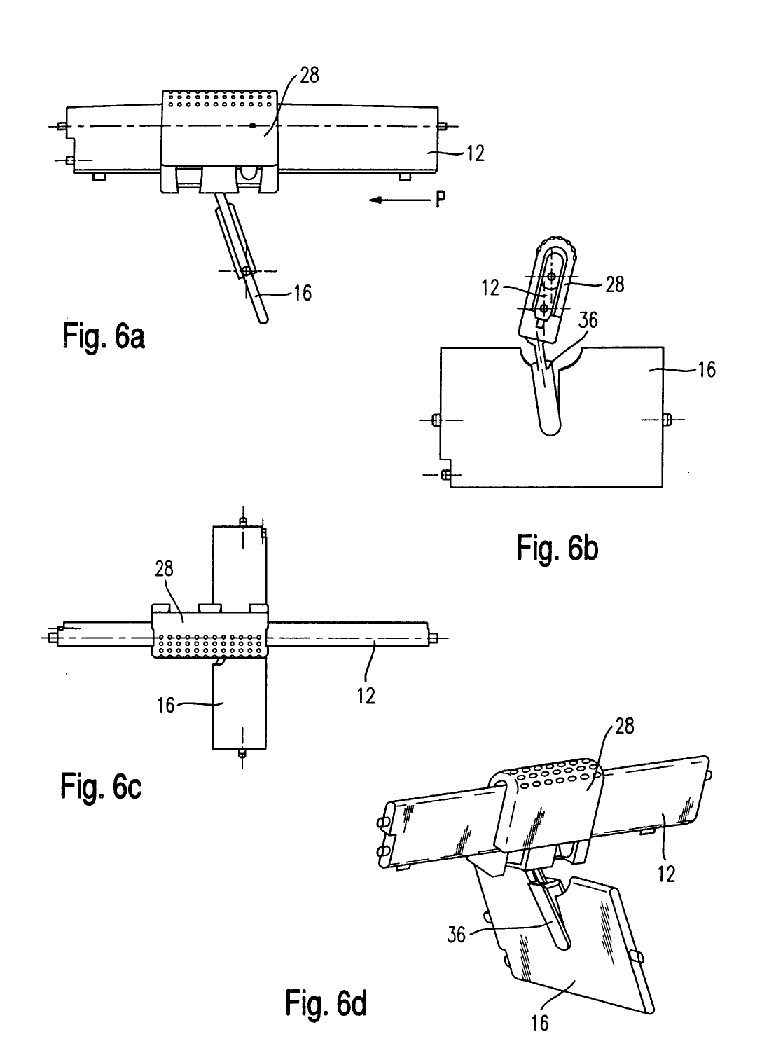

In FIG. 6 there is illustrated a position in which both the first blade 12 and the second blade 16 are each pivoted by 20 degrees. For this purpose the operational control 28, for one thing, has been shifted on the first blade 12 in the direction of arrow P and, for another, the first blade 12 has been pivoted about axis A by actuating the operational control 28. This results in a combined pivoting movement of the first blade 12 and the second blade 16.

1. An air vent, in particular for vehicular air conditioning, said air vent comprising a first blade pivotally mounted about a first axis in a frame, and a second blade pivotally mounted about a second axis in said frame, an operational control being arranged on said first blade and connected to said second blade via a slider/ball joint.

2. The air vent as set forth in claim 1, wherein said operational control on said first blade is shiftable parallel to said first axis.

3. The air vent as set forth in claim 1, wherein said slider/ball joint comprises a connecting part connected to said first and second blades.

4. The air vent as set forth in claim 3, wherein said connecting part is secured to said operational control by means of a ball joint and to said second blade by means of a slotted guide.

5. The air vent as set forth in claim 4, wherein said slotted guide is formed by a slot in said second blade in which a cross-web of said connecting part engages.

6. The air vent as set forth in claim 3, wherein said connecting part comprises two side webs supported by outer surface areas of said second blade.

7. The air vent as set forth in claim 1, wherein said first and second axes are arranged perpendicularly to each other.

8. The air vent as set forth in claim 1, wherein provided parallel to said first blade are further blades which are coupled to said first blade such that they are orientated the same as said first blade.

9. The air vent as set forth in claim 1, wherein provided parallel to said second blade are further blades which are coupled to said second blade such that they are orientated the same as said second blade.

10. The air vent as set forth in claim 8, wherein said first blade is provided with a journal which is engaged by a coupling rod.

11. The air vent as set forth in claim 9, wherein said second blade is provided with a journal which is engaged by a coupling rod.
